(19) United States
(12) Patent Application Publication
(10) Pub. No.: US 2009/0075686 A1
(43) Pub. Date: Mar. 19, 2009

(54) METHOD AND APPARATUS FOR WIDEBAND TRANSMISSION BASED ON MULTI-USER MIMO AND TWO-WAY TRAINING

(76) Inventors: Krishna S. Gomadam, Irvine, CA (US); Haralabos Papadopoulos, San Jose, CA (US); Carl-Erik W. Sundberg, Sunnyvale, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/209,110

(22) Filed: Sep. 11, 2008

Related U.S. Application Data
(60) Provisional application No. 60/973,625, filed on Sep. 19, 2007.

(51) Int. Cl. H04B 7/00

(52) U.S. Cl. 455/500

(57) ABSTRACT

A method, apparatus and system is disclosed herein for wireless transmission based on MU-MIMO and two-way training. In one embodiment, the system comprises a set of K receivers and at least one transmitter having a set of N transmit antennas, where the transmitter is operable to precode a signal for downlink transmission to each receiver in the set of K receivers based on multi-user MIMO using precoding derived based on two-way channel training between the set of K receivers and the set of N transmit antennas

### PRIORITY

The present patent application claims priority to and incorporates by reference the corresponding provisional patent application Ser. No. 60/973,625, titled, “A Method And Apparatus For Resource-Efficient Wideband Transmission Based On Multi-User MIMO and Two-Way Training,” filed on Sep. 19, 2007.

### FIELD OF THE INVENTION

The present invention is related to the field of wireless communication; more particularly, the present invention is related to wireless transmission based on Multi-User (MU) MIMO using two-way training between the transmitter and receivers.

### BACKGROUND OF THE INVENTION

Future wireless systems require a very efficient utilization of the radio frequency spectrum in order to increase the data rate achievable within a given transmission bandwidth. This can be accomplished by employing multiple transmit and receive antennas combined with signal processing. A number of recently developed techniques and emerging standards are based on employing multiple antennas at a base station to also improve the reliability of data communication over wireless media without compromising the effective data rate of the wireless systems. So called space-time block-codes (STBCs) are used to this end. Specifically, recent advances in wireless communications have demonstrated that by jointly encoding symbols over time and transmit antennas at a base station one can obtain reliability (diversity) benefits as well as increases in the effective data rate from the base station to each cellular user per unit bandwidth. These multiplexing (throughput) gain and diversity benefits depend on the space-time coding techniques employed at the base station.

The multiplexing gains and diversity benefits are inherently dependent on the number of transmit and receive antennas in the system being deployed, in the sense that they are fundamentally limited by the multiplexing-diversity trade-offs curves that are dictated by the number of transmit and the number of receive antennas in the system. A complimentary way of increasing the effectiveness/quality of transmission in the case of delivery of media, such as voice, audio, image and video, is to employ unequal error protection (UEP) methods.

A class of high data rate single-user MIMO systems exist today. These schemes are space-time bit-interleaved coded modulation systems with OFDM and can provide spatial temporal and frequency diversity. Furthermore, these schemes can inherently cope with the asynchrony created by transmission from non-collocated antennas at the transmitter. Moreover, by using a rate compatible punctured code as the outer binary code, a flexible UEP system is obtained for media transmission. One drawback with these systems, however, is that the near optimum receiver is sometimes very complex. In addition, to develop downlink SU-MIMO schemes with high aggregate spectral efficiency inherently requires the use of many receive antennas at the mobiles.

FIGS. 2 and 3 show the transmitter and receiver block diagrams for single-user MIMO/OFDM system with BICM and ID. FIG. 4 is a block diagram of a MIMO demapper having MIMO joint demapper units for the different OFDM tones/subchannels.

Multi-user MIMO (MU-MIMO) schemes present an attractive alternative to SU-MIMO systems. MU-MIMO systems can also achieve high aggregate throughputs, without, however, requiring large numbers of receive antennas at the mobiles, and with receivers with affordable complexity.

Unlike SU-MIMO, the performance gain of multi-user MIMO critically depends on the channel state information at the transmitter and the receivers. This naturally leads to the problem of acquiring channel state information both at the transmitter and each of the receivers. This leads to training and channel estimation, which is expensive in terms of system resources such as bandwidth and power, thereby reducing the net time for data transmission. Furthermore, the performance is hampered by the mismatch in the channel knowledge between the transmitter and the receiver.

### SUMMARY OF THE INVENTION

A method, apparatus and system is disclosed herein for wireless transmission based on MU-MIMO and two-way training. In one embodiment, the system comprises a set of K receivers and at least one transmitter having a set of N transmit antennas, where the transmitter is operable to precode a signal for downlink transmission to each receiver in the set of K receivers based on multi-user MIMO using precoding derived based on two-way channel training between the set of K receivers and the set of N transmit antennas

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a potentially asynchronous wireless wideband transmission from multiple antennas at potentially multiple base stations to mobile receivers (terminals).

FIG. 2 is a block diagram of one embodiment of a transmitter for space-time coding with bit-interleaved coded modulation (BICM) with OFDM modulation.

FIG. 3 is a block diagram of one embodiment of a receiver structure at any mobile receiver in a single user MIMO system.

FIG. 4 is a block diagram of one embodiment of MIMO demapper.

FIG. 5 is a block diagram of one embodiment of a multi-user MIMO transmitter.

FIG. 6 is a block diagram of one embodiment of a receiver structure for multi-user MIMO.

FIG. 7 illustrates one embodiment of a four-stage precoding formation and data transmission protocol.

FIG. 8A shows the setup to estimate the channel at the transmitter.

FIG. 8B shows how the effective channel is modified by the precoding matrix U.

FIG. 9 considers a sample scenario and shows the relation between the rate unicasted per user and the number of users in outage (i.e., the number of users that are not able to reliably decode at that rate)

FIG. 10 is a block diagram of one embodiment of a computer system.

### DETAILED DESCRIPTION OF THE PRESENT INVENTION

A wireless communication system is disclosed for managing sending/receiving information with multiple transmit antennas and, potentially, multiple receive antennas. The system includes terminals (e.g., mobiles) that receive (by use of one or several antennas) a signal that is sent over multiple transmit antennas and where the transmit antennas may (or may not) be distributed over multiple base stations (i.e., the antennas may or may not be collocated). In one embodiment, wideband transmission with OFDM is used with an outer binary convolutional code, which is based on bit-interleaved coded modulation. In contrast to conventional single-user MIMO systems, two-way channel training is employed and used to design an instantaneous precoder method with the goal of optimizing the aggregate data rates delivered to the users. In one embodiment, these types of systems where the precoder is designed and optimized at the transmitter for the particular channel realization are referred to as multi-user MIMO systems. Finally, the disclosed multi-user MIMO techniques also make provisions for optional flexible unequal error protection for media signals.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

Techniques described herein deal primarily with the forward link, i.e., the base-to-mobile direction of transmission. Methods and apparatuses are disclosed for reliably transmitting an information-bearing stream of symbols from multiple antennas, residing at one or more base stations, to potentially large numbers of designated simple mobile receivers, each with typically, one or two antennas. The methods and apparatuses achieve desired objectives of reliable transmission by employing channel state information at the transmitter (CSIT). In one embodiment, this is accomplished by use of a precoder. The base-to-mobile channels are estimated by using a channel-reciprocity property and a time-division duplexing (TDD) procedure, i.e., by probing on the reverse (i.e., mobile-to-base) channels. The system also uses channel training in the forward (base-to-mobile) link to provide pertinent channel state information at the receivers (CSIR). In one embodiment, a potentially very large number of (possibly non-collocated) base-station antennas are included in the wireless system. In one embodiment, the receivers in the system have only one receive antenna and are of low complexity.

In one embodiment, the system is designed for simultaneous high-rate delivery of information from a transmitter that uses a (very) large number of antennas to multiple individual users with very few antennas, preferably only one. This is possible by making use of channel state information at the transmitting base-station (through channel state estimation) in designing a method for precoding (beam-forming) the data streams prior to transmission. Such techniques, whereby channel state information is used at the transmitter for precoding in a multi-user transmission setting are referred to as multi-user MIMO schemes. When a large number of transmit antennas is employed relative to the number of simultaneous users (each with typically one single antenna), linear precoding suffices for delivering high aggregate rates.

In one embodiment, TDD reciprocity is assumed, so that the channel state information at the transmitter for all the forward-link channels between the N transmit antennas and the antennas of the K users are acquired by measurements made at the transmitter based on pilots sent by the K users in the reverse link. The resulting channel estimates at the transmitter are collectively referred to as channel state information at the transmitter (CSIT). Although the CSIT estimates are not “perfect” estimates of the forward-link channels, CSIT is used to generate the precoding method for the downlink transmission. In general, the effectiveness of the precoder strongly depends on the quality of the CSIT as well as other related parameters, such as the channel coherence time (which in turn depends on the user mobility levels), the number of transmit antennas, at the base stations and the number of users, K. A linear precoder based on MMSE or regularized zero-forcing can be employed at the transmitter yielding in many cases of practical interest, robust and effective systems. The precoder unit is the most complex unit in the transmitter and its complexity is proportional to at most K³ (i.e., K to the third power).

In one embodiment, a wireless communication system comprising: a set of K receivers; and at least one transmitter having a set of N transmit antennas, where the transmitter is operable to precode a signal for downlink transmission to each receiver in the set of K receivers based on multi-user MIMO using precoding derived based on two-way channel training between the set of K receivers and the set of N transmit antennas. The two-way training may be coordinated and portions performed by a two-way training module in the transmitter. In one embodiment, the two-way channel training includes uplink training using K pilot signals and downlink training using 1 to K symbols. In one embodiment, the precoding is performed using one or more MU-MIMO precoders derived via reciprocity-derived channel state information at the transmitter (CSIT). In one embodiment, the CSIT is acquired by measurements made at the transmitter based on pilots sent by the set of K receivers.

In one embodiment, the set of K receivers and the set of N transmit antennas employ a four stage TDD-based training and transmission protocol. In one embodiment, the four stage TDD-based training and transmission protocol comprises: the transmitter estimating channels directly based on received on K pilot symbols, each K pilot symbol being transmitted by one of the set of K receivers; deriving the MU-MIMO precoder using the channel estimates; the transmitter transmitting 1 to K pilot symbols using the MU-MIMO precoder to the set of K receivers to enable the K receivers to estimate their respective effective channels; and the transmitter performing unicast downlink transmission using the MU-MIMO precoder. Note that stage 1 (uplink pilot signaling and transmitter training) precedes all other stages, and stage 2 (precoder design) precedes stages 3 and 4. However, there is no causality requirement between stages 3 and 4, i.e., samples for the downlink training stage can be interlaced in arbitrary ways with samples of the downlink data transmission stage (and in general it is advantageous to do so).

In one embodiment, the two-way training unit derives the set of precoders. In one embodiment, the transmitter comprises a plurality of precoders, wherein each of the plurality of precoders is dedicated to one channel. In one embodiment, the transmitter generates a compound precoded signal using channel estimates generated by the at least one transmitter, where the compound precoded signal is such that each receiver in the set of K receivers only decodes its own signal.

In one embodiment, the transmitter comprises a two-way training unit to estimate channels directly and a space-time encoding system. In one embodiment, the two-way training unit supplies the channel estimates to the precoder. In one embodiment, the space-time encoding system comprises: an input to receive information bearing signals; a binary outer code encoder coupled to the input to encode the information bearing signals and generate a bit stream; a bit interleaver coupled to receive the bit stream; a mapper and a modem coupled to the bit interleaver, wherein the bit interleaver, mapper and modem operate together to yield bit-interleaved coded modulation; a set of precoder units to shape a signals for transmission based on channel state information indicative of channel estimates that were estimated directly by the unit of the transmitter; and an OFDM transmission system (e.g., an OFDM-based inner orthogonal space-time block code encoder) coupled to the set of precoder units to generate a plurality of streams for transmission. In one embodiment, the OFDM transmission system is designed to handle the wideband transmission and be robust to the potentially asynchronous nature of the received signals from non-collocated antennas. In one embodiment, the modem and the set of precoders are coupled via a serial-to-parallel converter that is operable to convert outputs of the bit-interleaving from serial to parallel form. In one embodiment, the transmitter is part of a base station.

The precoder units make up a linear or nonlinear precoder, which takes as input the outputs of the outer binary codes for all user streams, and whose output is used as input to the OFDM transmission system. Based on the available channel information (estimates), the precoder prepares a jointly transmitted signal in such a way that the signal intended for any user can be decoded by that user, and a simple receiver with one antenna is sufficient for that purpose.

In one embodiment, a receiver in the wireless communication system comprises: a linear front-end having an inner decoder to perform decoding with an OFDM-based inner orthogonal space-time block code to generate symbols; and an outer decoder having an inner symbol demapper to perform a symbol-by-symbol demapping of symbols to bits from the linear front-end, a bit deinterleaver to perform deinterleaving on the demapped symbols received from the inner symbol demapper, and an outer MAP decoder.

In one embodiment, the wireless communication system described herein provides the following main advantages: a large system sum capacity is achieved by using a large number of transmit antennas and channel state information at the transmitter which leads to beam forming advantages and spatial multiplexing; for the case of a very large number of transmit antennas compared to the number of users a linear precoder is sufficient; a receiver structure with only one antenna yields good performance and capacity, which leads to very low receiver complexity and a preferred receiver form factor; iterative decoding may be employed at the receiver for improved performance; and unequal error protection for media transmission is also an option.

### Examples of Transmitter and Receivers for Single User and Multi-User MIMO Systems

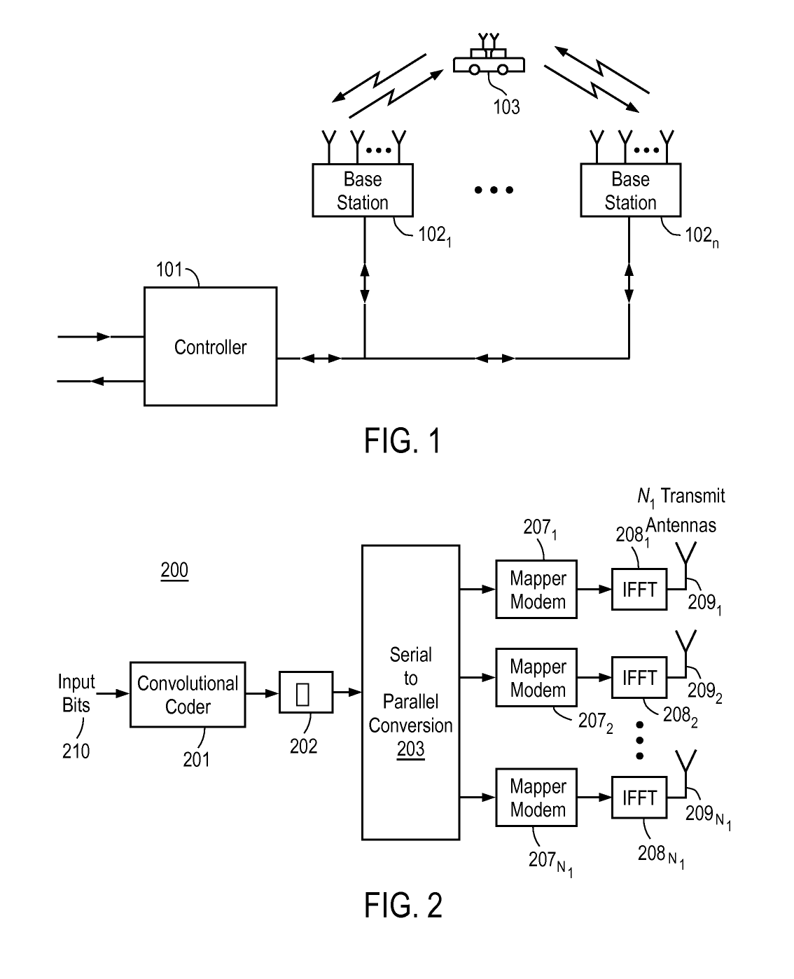

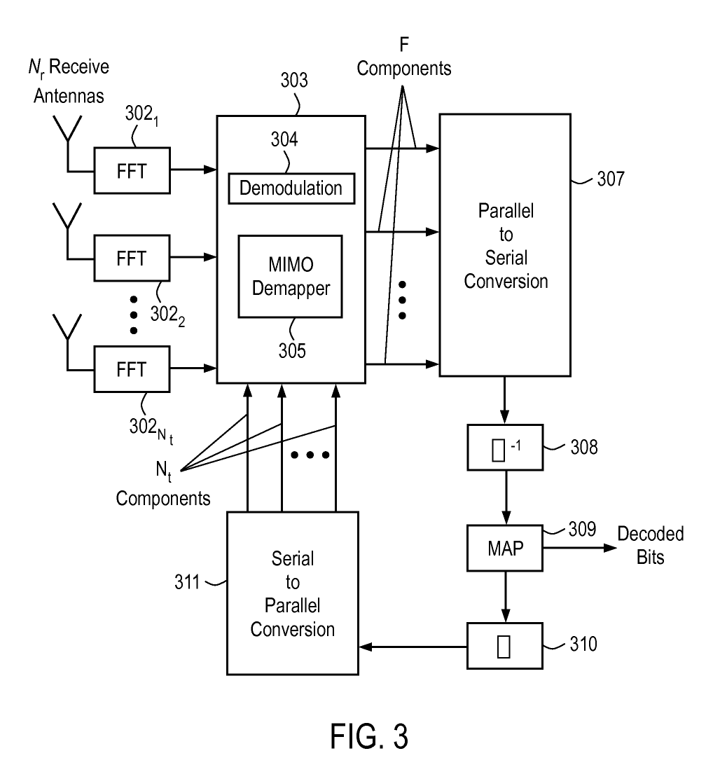

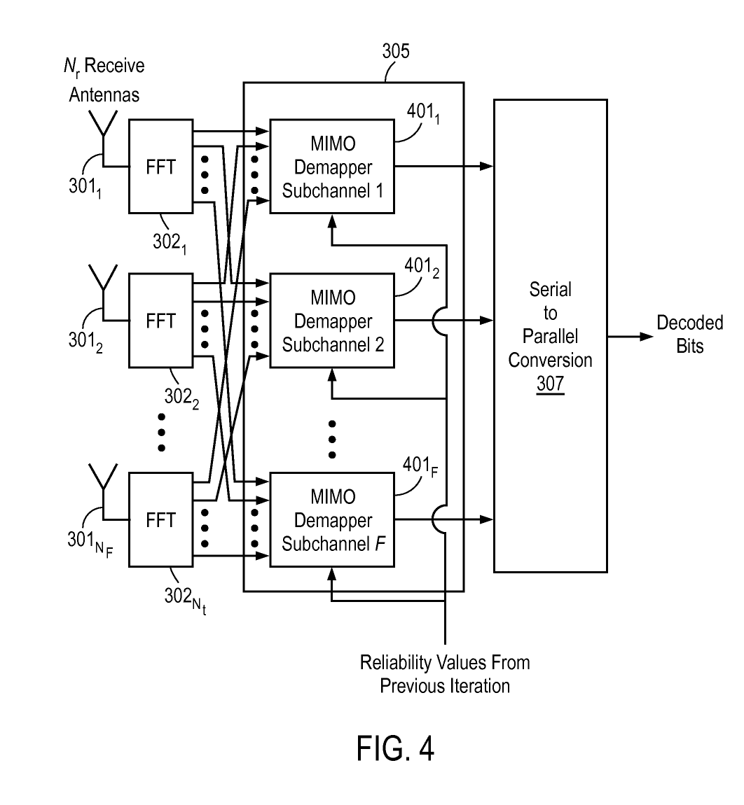

FIG. 1 illustrates a potentially asynchronous wireless wideband transmission from multiple base stations to mobile receivers (terminals). Referring to FIG. 1, multiple base stations 102₁₋ₙ are shown, and each of these base stations has, potentially, multiple antennas for communicating with mobile receivers, such as mobile receiver 103. Each transmitting base station of base stations 102₁₋ₙ has available the same information-bearing symbol stream that is to be communicated to the receiver(s) 103. In one special case of interest, the information bearing signals are transmitted from a single site.

Central control unit 101 is communicably coupled to base stations 102₁₋ₙ to control base stations 102₁₋ₙ. In one embodiment, control unit 101 manages the information flow (signals) to and from the involved base stations/transmit antennas as well as channel identification algorithms. Control unit 101 selects the transmit antennas and base stations from a collection of available base stations. In one embodiment, control unit 101 communicates with the (transmitting) base stations 102₁₋ₙ via wire (or wireless broadcast). It should be noted that the signals transmitted from any two antennas (whether the antennas reside on the same or on different base stations) are typically not the same, just as is the case with existing space time code designs for systems with collocated transmit antennas.

### An Example of a Multi-User MIMO Transmitter

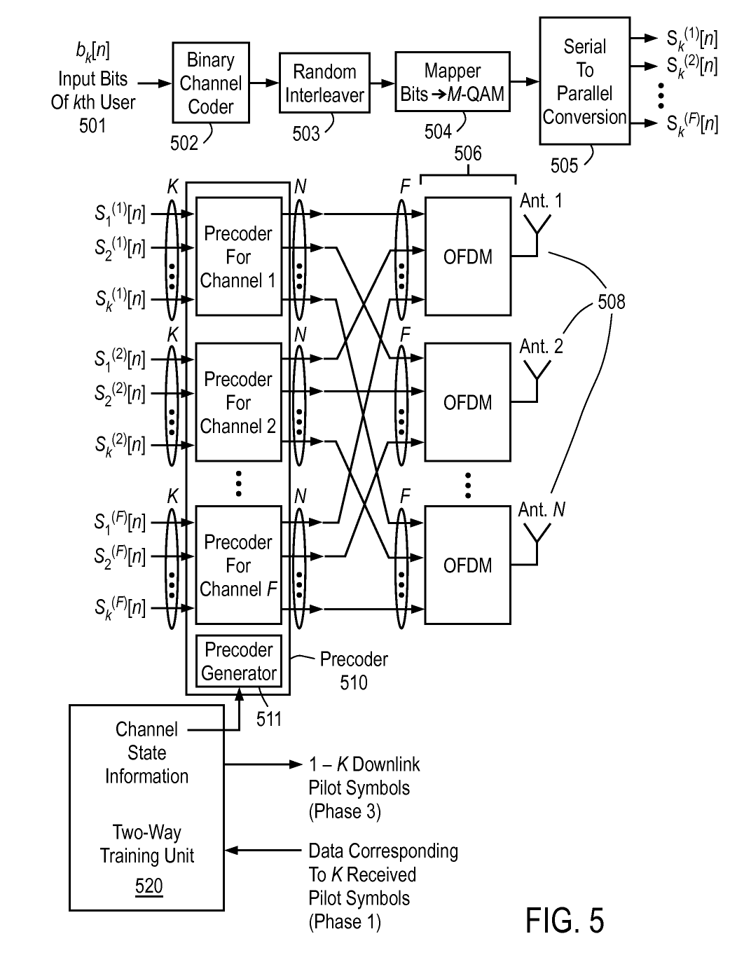

FIG. 5 is a block diagram of one embodiment of a multi-user MIMO transmitter, involving K users, N transmit antennas at the base station and F tones in the OFDM system.

Referring to FIG. 5, an information bearing digital signal stream to user k, where k=1, 2, . . . , K (i.e., the input bits of the kth user (bₖ[n]) 501) is first encoded by an outer binary code using binary channel coder 502. The binary code may be, for example, a block code, an LDPC code, a convolutional code, an RCPC code for UEP applications, or a turbo code. Following binary coding, a bit-interleaved coded modulation (BICM) system is created with coding over the F subtones in an OFDM system (the binary outer code is effectively operates over all the OFDM tones combating frequency selective fading and providing frequency diversity). To that end, following binary channel coder 502 is a bit interleaver 503, followed by a mapper/modulator unit 504, which operate in a manner well-known in the art. In one embodiment, interleaver 503 is a random interleaver that interleaves the encoded bits from binary channel coder 502 to generate BICM encoded data. Mapper/modulator 504 maps bits from interleaver 503 to M-QAM (e.g., 16 QAM, 64-QAM, etc.). The output of mapper/modulator 504 is then converted into vector parallel streams by serial-to-parallel (S/P) converter 505. The outputs of serial-to-parallel (S/P) converter 505 represent the tones 1 to F to be transmitted.

Then, all K coded user streams associated with a particular tone are jointly precoded by a precoder designed for that particular tone. In one embodiment, precoder 510 includes multiple precoder units, one for each channel. That is, there is a precoder for each channel (precoder for channel 1, precoder for channel 2, . . . precoder for channel F). Thus, the precoding performed by the precoder is performed on each of the tones separately.

On each tone, the precoder is formed by precoder generator 511 of precoder 510, by deriving the precoding units using CSIT information, obtained by pilot transmission in the reverse link on the same tone, exploiting the notion of channel reciprocity (if the reverse and forward link transmission are with the coherence time of the channel the two channels are approximately the same), as is described below. The CSIT information is supplied as channel state information from two-way training unit 520, which receives the data corresponding to the K received pilot symbols and calculates the CSIT information. In one embodiment, the CSIT and CSIR (channel state information at the receivers) are calculated for each of the F tones. Note also that in one embodiment it is assumed that the wireless communication system is low mobility and a block fading type channel environment with high data rates.

For a given tone, precoder 510 generates a vector with dimension N, and where N is the number of base station antennas, and whereby the ith element corresponds to what would be transmitted over the ith antenna on that particular tone.

The ith element of the output vector from each precoder for channels 1-F are encoded according to the OFDM-based orthogonal space-time block code system 506 and transmitted over transmit antennas 508₁-508_{N}, in a manner well-known in the art.

Two-way training unit 520 also causes the transmitter to transmit 1-K downlink pilot symbols during stage 3 of the four-stage precoding formation and data transmission protocol described below.

Note that, throughout these figures and accompanying text, Nₜ=N and Nᵣ denote the number of transmit and receive antennas, respectively, while F denotes the number of OFDM frequency components.

### An Example of a Multi-User MIMO Receiver

In one embodiment, the receiver used at the mobile receiver comprises a linear front-end for the orthogonal non-binary space-time block code resulting in symbol-by-symbol modem demapper decisions, a deinterleaver and a maximum a posteriori probability decoder for the outer convolutional code. In one embodiment, iterative decoding is performed by using the demapper as the inner MAP decoder. Non-iterative receivers that are based on the Viterbi algorithm correspond to reduced-complexity options and may also be used.

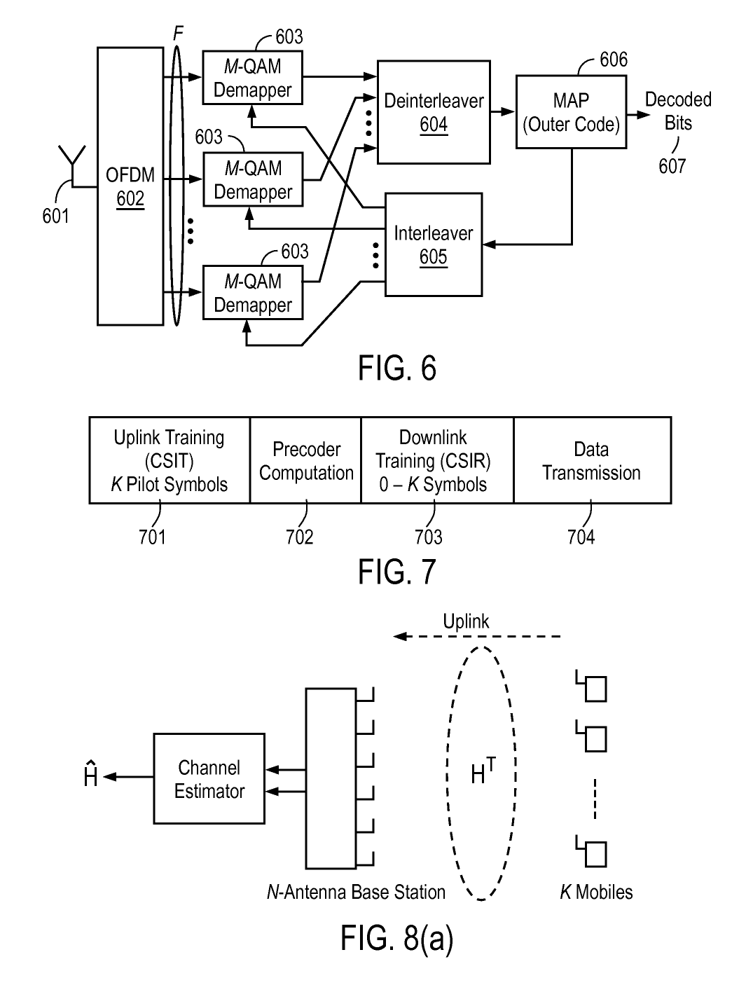

FIG. 6 is a block diagram of one embodiment of a receiver structure at a mobile receiver for use with the encoder of FIG. 5. Referring to FIG. 6, the receiver comprises a linear front end 602 that performs OFDM demodulation for each receiver antenna 601. Antenna 601 senses a signal made up of various combinations of signals transmitted from the transmit antenna. Linear front end 602 includes FFT modules to apply an F-point FFT to the corresponding signals of the receiver antenna 601 generating F subchannels for the inner code, followed by a decoder for the outer code system. After demodulation, carrier/timing recovery and baud-rate sampling, a linear receiver front-end 602 is employed by exploiting channel estimates and relative delay of arrival estimates for each transmit-antenna to receive-antenna channel. The output of the linear front end 602 is a single baud-rate sequence that is demodulated demapped and deinterleaved demodulator/demapper unit 603, the output of demodulator/demapper 603 is input to bit deinterleaver 604. The inner demapper MAP decoder 603, which provides soft bit estimates for the outer binary code, has a very modest complexity that is a substantially lower than the corresponding unit in many single-user MIMO systems. For 16 QAM modulation, for instance, this unit in the Multi-user MIMO case only has to perform 16 alternatives.

Deinterleaver 604 and an outer decoder 606 follow demapper 603. Bit deinterleaver 604 performs bit deinterleaving. The output of bit deinterleaver 604 are sent to the outer decoder 606. In one embodiment, outer decoder 606 is of Maximum a Posteriori (MAP) type, which obtains an estimate of the information-bearing signal 607. New MAP estimates are obtained iteratively by using as inputs to the demapper re-interleaved versions of the current MAP estimates created by bit interleaver 605, which are sent to demodulator/demapper 603. Thus, if outer decoder 606 is of MAP type, iterative decoding (ID) is also a possibility in the receiver (as shown in FIG. 6).

MAP decoder 606 performs the MAP decoding process to generate soft output values for transmitted information bits in a manner well-known in the art. By performing an iterative process with MIMO demapper 603, the soft output values may become more reliable. In one embodiment, the MAP decoder 606 comprises the MAP decoder described in U.S. patent application Ser. No. 12/121,634, entitled “Adaptive MaxLogMAP-Type Receiver Structures,” filed on May 15, 2008. Also, the MIMO demapper 605 can be MAP, MaxLogMap, improved MaxLogMAP, SOMA, or any other reduced-complexity inner-demapper algorithm.

Note that in other embodiments a non-MAP (non-iterative) decoder may be used for the receiver.

In one embodiment, users having multiple receive antennas. For example, for Kₒ users, the k^{th} user has Nr(k) antennas. Thus, a system has K=sum_{k=1}̂{Kₒ} Nr(k) virtual users, each with a single receive antenna (and where the kth actual user has Nr(k) virtual user streams sent to it). These technologies can be applied to such a system where each virtual user represents a separate receive antenna.

### Four-Stage Precoding Formation and Data Transmission Protocol

FIG. 7 illustrates one embodiment of a four-stage precoding formation and data transmission protocol that is exploited for obtaining channel state information and setting up the precoder at the base station, for performing receiver training in the forward link, and for transmitting data in the forward link. The training takes place both for the uplink (CSIT) and the downlink (CSIR).

Referring to FIG. 7, as set forth in the four-stage precoding formation and data transmission protocol (which applies for each tone in the OFDM system separately), during stage 1 (701), K pilots are transmitted in the reverse link, and all the channels between the N base-station antennas and the K user-antennas are estimated. In stage 2 (702), the precoder is computed at the base station based on these estimates. In stage 3 (703), the precoder is used along with pilot symbols for downlink transmission from the base station, in order to estimate the effective channels seen by each user. In stage 4 (704), the precoder is used for downlink data transmission by the base station (using the system of FIG. 5), and the receiver of FIG. 6 is used at each receiver, together with the channel estimates obtained in stage 3. Note again that, in practice, it may be advantageous to group stages 3 and 4 into one common stage, by interlacing the transmissions associated with stages 3 and 4.

The four-stage precoding formation and data transmission protocol will be described in more detail below. This discussion starts with a discussion of the system model.

### System Model

Considering the forward-link of a flat fading wireless communication system with N transmit antennas at the base station and K single-antenna users (where, for a wideband system with OFDM, the model represents the channel model for a given OFDM tone), sₖ denotes the symbol that is to be transmitted to receiver k (with E[|sₖ|²]=P_{F}), and let s=[s₁ . . . s_{K}]T. Letting the N×1 vector x denote the precoded version of s that is transmitted by the N base station antennas, the received signal at the kth user is given by

yₖ=hₖ^{T}x+nₖ k=1,2, . . . , K (1)

where hₖ denotes the N×1 vector of channel coefficients between the base station antennas and the kth receiver, and nₖ˜CN(0,1) denotes white Gaussian noise. In one embodiment, it is assumed that the hₖ's are statistically independent and that hₖ˜CN(0,I). In matrix form, equation (1) can also be expressed as

y=Hx+n (2)

where y=[y₁ . . . y_{K}]T, H=[h₁ . . . h_{K}]T, and n=[n₁ . . . n_{K}]T. In one embodiment, a quasi-static channel model is assumed, i.e., it is assumed that the channel matrix H remains constant for a coherence interval of T symbols.

### Four-Stage Training Protocol

During a T-symbol duration corresponding to one coherence interval (and where we assume that T>2K), the four-stage protocol is exploited for two-way training and data transmission as shown in FIG. 7. In the first stage of the protocol, K pilots are transmitted in the reverse link by each user. Based on the received samples at the base station and exploiting reverse-link forward-link channel reciprocity the transmitter obtains CSIT, i.e., it obtains Ĥ, an estimate of H in (2). This estimate is then used to form the MU-MIMO precoder (stage 2). In one embodiment, the precoders are linear precoders, i.e., precoders of the form

$$x = Us = {\sum }_{k = 1}^{N} {u}_{k} {s}_{k} , \qquad ( 3 )$$

where U=U(Ĥ) is an N×K unit-norm precoding matrix, i.e., it satisfies the following norm constraint:

TR(UU^{†})=1 (4)

and where uⱼ denotes the jth column of U. Note that right after stage 2, none of the K receivers knows Ĥ, or U (the precoding method). During stage 3, L pilots (with 1≦L≦K) are sent in the forward link using the precoder designed during stage 2, in order to provide to the receivers estimates of their effective channels. Note that the base station does not know the effective channel estimate obtained at each receiver during stage 3. Finally, during stage 4, the precoder designed in stage 2 is reused for data transmission to all K users. Each of the four stages of the protocol is discussed in more detail below.

### Stage 1: Uplink Training

The first stage is an uplink channel-state estimation process (first stage in FIG. 6). The users simultaneously transmit pilot sequences of length at least K slots. After obtaining measurements on this pilot transmission, the base station then employs an MMSE or similar channel estimation scheme to obtain an estimate of all base-to-mobile channels from the received pilot sequence (in a manner well known in the art). One well known example of pilots corresponds to using K pilot vectors (one per user), whereby each of the vectors have dimension K (and where the ith element represents what is transmitted by the use during pilot slot i), and where all vector have the same power and are orthogonal to each other. The CSIT (which is typically imperfect, i.e., the estimates of the channels are not exactly equal to the channels in question) is used to design the precoder.

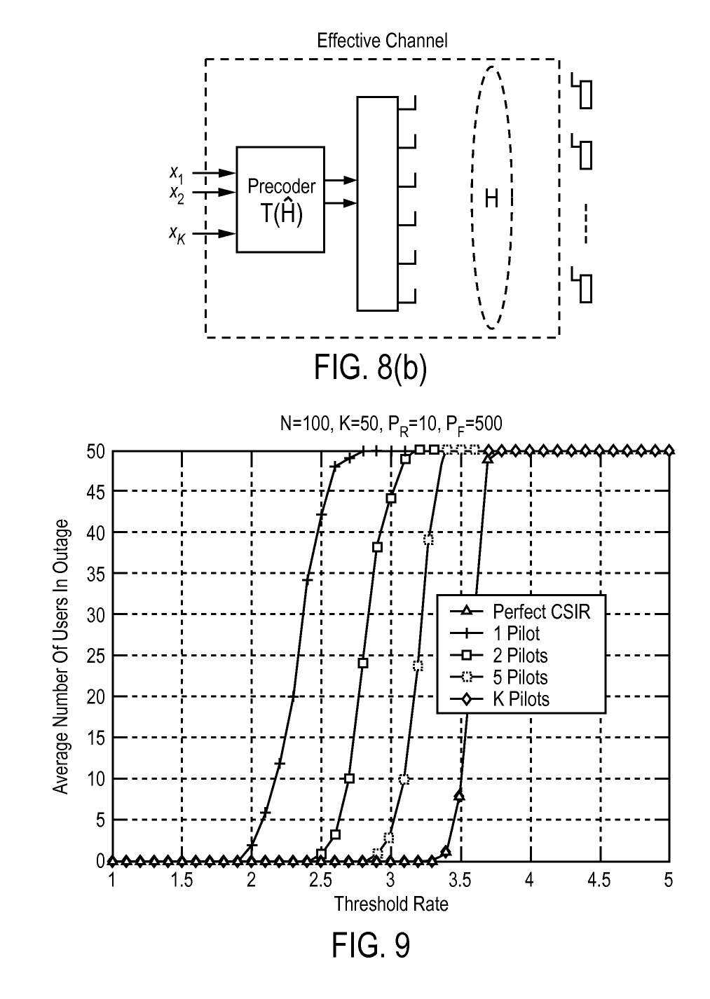

FIG. 8A depicts the reverse-link training that is employed during stage 1 in order to provide channel estimates at the base station. It is assumed that K slots are expended for the reverse link training, with P_{R} denoting the normalized pilot power level at each of the mobiles. Let AR denote the K×K orthogonal pilot matrix, whereby the (i, j)th entry denotes the pilot transmitted by user j during slot i. Assuming uplink-downlink channel reciprocity and MMSE channel estimation at the transmitter, the resulting transmitter channel estimate can be modeled as

$$\hat{H} = \frac{{P}_{R}}{{P}_{H} + 1} H + \frac{\sqrt{{P}_{R}}}{{P}_{R} + 1} V$$

where V is a K×N noise matrix with independent CN (0,1) entries. Letting also ΔH=H−Ĥ denote the channel estimation error matrix, it is noted that the components of ΔH are independent

$$CN ( 0 , \frac{1}{{P}_{N} + 1} )$$

random variables.

Given any precoder U, y in equation (2) can be expressed as follows

$$\begin{matrix}y = ( \hat{H} + Δ H ) U ( \hat{H} ) s + n \\ = \hat{H} {\sum }_{j = 1}^{K} {u}_{j} {s}_{j} + Δ H {\sum }_{j = 1}^{K} {u}_{j} {s}_{j} + n ,\end{matrix} \qquad \begin{matrix}( 5 ) \\ \\ ( 6 )\end{matrix}$$

and, consequently, the received signal at the kth user as follows:

$$\begin{matrix}{y}_{k} = {h}_{k}^{T} {u}_{k} {s}_{k} + {\sum }_{j = 1 , j \neq k} {h}_{k}^{T} {u}_{j} {s}_{j} + {n}_{k} \\ = ( {\hat{h}}_{k}^{T} {u}_{k} + Δ {h}_{k}^{T} {u}_{k} ) {s}_{k} + {\sum }_{j \neq k} ( {\hat{h}}_{k}^{T} {u}_{j} + Δ {h}_{k}^{T} {u}_{j} ) {s}_{j} + {n}_{k} \\ = ( {a}_{kk} + Δ {a}_{kk} ) {s}_{k} + {\sum }_{j \neq k} ( {\hat{a}}_{kk} + Δ {a}_{kj} ) {s}_{j} + {n}_{k} .\end{matrix} \qquad \begin{matrix}( 7 ) \\ \\ \\ \\ ( 8 )\end{matrix}$$

FIG. 8B is a pictorial representation of equation (8), illustrating how the precoding strategy converts the multi-user MIMO channel to an interference channel with K transmitters and K receivers. The overall precoding operation is denoted by T(.). The effective channels shown in FIG. 8B depend greatly on the precoding strategy. Note that, given the estimate Ĥ and knowledge of the CSIT quality (determined by P_{R}), the transmitter has also knowledge of the effective channel mean âₖⱼ and the statistical characterization of Δaₖⱼ, for all j, k2{1 . . . K}.

### Stage 2: Precoder Design

The choice of the linear precoder affects the MU-MIMO benefits in terms of the resulting effective channel gains {aₖⱼ}. The most commonly studied linear precoder is the linear zeroforcing (ZF) precoder. It takes the form

$${U}_{zf} = \frac{1}{\sqrt{Tr ( {( \hat{H} {\hat{H}}^{†} )}^{- 1} )}} {{\hat{H}}^{†} ( \hat{H} {\hat{H}}^{†} )}^{- 1} . \qquad ( 9 )$$

For the case of perfect CSIT, zero-forcing results in aₖⱼ=0, ∀j≠k. Although zero-forcing yields the maximum spatial multiplexing gain, it has the following limitations:

In the case that K and N are large and K is close to N, the channel coefficient associated with the signal component at the k receiver, i.e.,

$${a}_{kk} = \frac{1}{\sqrt{Tr ( {( \hat{H} {\hat{H}}^{†} )}^{- 1} )}} ,$$

a quantity that is dominated by the minimum eigenvalue of ĤĤ^{†}. As the number of users increases, the signal term approaches zero, suggesting a need to regularize the inverse.

In the presence of partial CSIT, the desirable property of zero-forcing, which is to null the interference, is lost when the channel estimates are noisy.

Two robust linear precoders that take into account the CSIT quality and the number of users in the system are designed. Either of these may be used:

1) MMSE filters from the associated uplink scenario: With perfect CSIT, optimal linear filters for the downlink can be obtained by solving the dual uplink problem. However, optimality is not guaranteed with imperfect CSIT, as the uplink-downlink duality does not hold in general. Below, an uplink channel that is closely related to the downlink is considered although they are not duals. The channel state information at the receiver (CSIR) for the uplink problem is assumed to be of the same quality as that of the CSIT in the downlink. The following linear MMSE precoding vector for user k may be obtained:

$${u}_{k} = {( {\sum }_{j \neq k} {\hat{h}}_{j}^{*} {\hat{h}}_{j}^{T} + \frac{K}{{P}_{R} + 1} I + \frac{I}{{P}_{F}} I )}^{- 1} {\hat{h}}_{k}^{*} \qquad ( 7 )$$

where hⱼ is the j^{th} column of the channel estimate H.

2) Sum-MSE minimization: Regularizing the zero-forcing is closely related to the MMSE minimization problem. Consider the following optimization problem

$${min}_{U , β} E [ {‖ ( β y - s ) ‖}^{2} ] such that E [ {‖ ( Us ) ‖}^{2} ] = {P}_{F} .$$

whose solution results in

$$U = {c ( {\hat{H}}^{†} \hat{H} + \frac{K}{{P}_{R} + 1} I + \frac{K}{{P}_{F}} I )}^{- 1} {\hat{H}}^{†} , \qquad ( 11 )$$

where c ensures compliance with the power constraint and where H is a matrix of K rows and N columns comprising the channel estimates at the transmitter; K denotes the number of users; N denotes the number of transmit antennas; P_{R} denotes the reverse link signal-to-noise ratio (SNR) (this quantity is used to obtain the CSIT quality); and P_{F} denotes the forward link SNR (used to obtain CSIR and also used for data transmission). The above solution for the precoder minimizes the sum MSE of all the receivers.

The kth column of the precoder is given by

$${u}_{k} = {{c}_{k} ( {{\sum }^{K}}_{j = k} {\hat{h}}_{j}^{*} {\hat{h}}_{j}^{T} + \frac{K}{{P}_{R} + 1} I + \frac{K}{{P}_{F}} I )}^{- 1} {\hat{h}}_{k}^{*} . \qquad ( 12 )$$

A single-user (SU) beamforming scheme may be used, i.e. a scheme where the precoding vector uₖ is selected (independently of the channels of all the other users) via beamforming along the direction of the vector channel associated with the kth receiver, i.e.,

$${U}_{ct} = \frac{{\hat{H}}^{†}}{\sqrt{Tr ( \hat{H} {\hat{H}}^{†} )}} \qquad ( 13 )$$

### Stage 3: Downlink Training

During stage 3, the transmitter sends pilots via the precoder derived in stage 2 for training in the forward link. The downlink channel estimation stage consists of a pilot sequence of length L where the value of L is a design parameter that depends on the coherence interval of the channel. Although in general, L can take values between 0 (no training) and infinity, the values of L that are sensible in practice range from 1 to K. A typical channel estimation scheme with L pilots is described below.

In response to pilot sequence, each receiver obtains estimates of the actual channel coefficients, i.e., estimates of aₖⱼ=âₖⱼ+Δaₖⱼ and not of the transmitter channel estimates âₖⱼ. In one embodiment, the downlink training schemes are used in which L orthogonal K×1 pilot vectors are via the precoder designed in stage 2, and where 1≦L≦K. In the case that L is a factor of K, one such set of pilot vectors takes the following form:

$${x}^{p} ( n ) = \sqrt{{c}_{n}} {\sum }_{j = ( n - 1 ) k / L + 1}^{nK / L} \sqrt{{LP}_{F} {u}_{j}} , n ∈ \{ 1 … L \} ,$$

where cₙ ensures compliance with the peak power constraint. In the “large N” case of interest, due the symmetrical structure of the precoder, it follows that

$${‖ {\sum }_{j = ( n - 1 ) K / L + 1}^{nK / L} \sqrt{{LP}_{F}} {u}_{j} ‖}^{2} \approx {LP}_{F} \frac{K}{L} \frac{1}{K} = {P}_{F} ,$$

which results in cₙ≈1, where uⱼ is the j^{th} column of the precoder (linear or non-linear). The received sample at the kth receiver during the nth training slot is given by

$${y}_{k}^{p} ( n ) \approx \sqrt{{c}_{n}} {\sum }_{j = ( n - 1 ) K / L + 1}^{nK / L} {a}_{kj} \sqrt{{LP}_{F} + {n}_{k} ( n )} .$$

In one embodiment, receiver k estimates its desired-signal channel from the received pilot

$${y}_{k}^{P} ( ⌈ \frac{Lk}{K} ⌉ ) ,$$

where ┌x┐ outputs the smallest integer greater than or equal to x. The rest of the pilots can be utilized to estimate one of the channels of the interfering signals in each pilot, i.e. (L-1) out of K −1 interfering channels are estimated with (L −1) pilots. Let āₖₖ and (σ_{δkk}²) denote the channel estimate and mean squared estimation error of the estimate error at the receiver. The receive estimate āₖₖ is different from âₖₖ, the transmitter estimate of aₖₖ.

The value of L can be adapted to the channel coherence time interval. Typically, for slow fading channels, L=K pilots can be utilized, resulting in a performance that is equivalent to the perfect CSIR case. For fast fading channels, one pilot symbol may prove sufficient to achieve good performance (i.e., achieve good trade off between overhead training and channel estimate quality).

FIG. 9 shows the number of users in outage versus the threshold rate to reliably decode, for a random channel realization for N=100 and K=50. The robustness of L=1, 2, 5, and 50 downlink channel estimation schemes can be noticed. Note that, alternatively, given any L that is at most as large as K, pilots can be obtained by taking L columns of an orthogonal matrix of K rows and columns, and using the nth sample on the kth row of the remaining matrix (of K rows and α columns) as the pilot that is to be sent on the kth steering vector of the precoder at the nth slot. The value of L can be further optimized depending on the system requirements. The case “L=0” (i.e., no downlink training) can still be of value, if for instance, differential PSK were employed.

### Stage 4: Downlink Transmission

In the final stage of the protocol, the transmitter uses the precoder designed in stage 2 to unicast data to all the users. Each user then employs a receiver based on the effective channel estimate it obtained during stage 3 in order to decode its data. In practice, stages 3 and 4 can be interlaced in arbitrary ways. In particular, a single stage can be employed with the L samples corresponding to “stage 3” uniformly spread over the common stage. At each receiver, however, in general, the receiver's channel would be first estimated based on the L stage-3 samples this receiver receives, followed by decoding the data based on observation of the remaining received samples from the common stage transmission. Thus, stage 3 samples may be spread over the data samples of stage 4.

### Precoder Derivation

In the following, the precoders given by equations (10) and (12) above are derived.

### A. Duality Method

Consider a multiple access channel with K users each with transmit power

$$\frac{{P}_{F}}{K} .$$

Let H^{†} be the channel matrix with Ĥ^{†} as the channel estimate at the receiver. The components of the estimation error (H^{†}-Ĥ^{†}) are i.i.d.

$$CN ( 0 , \frac{1}{{P}_{R + 1}} ) .$$

Note that the channel estimate quality is derived in the same manner as in the downlink case. As a result, the received signal at the receiver of the uplink can be written as

$$y = {\sum }_{j = 1}^{N} ( {\hat{h}}_{j}^{*} + Δ {h}_{j}^{*} ) {x}_{j} + n$$

By treating the channel estimation error as another interference term, the combining vector that maximizes the signal to interference plus noise ratio (SINR) for the kth user is

$${u}_{k} = {( {\sum }_{j \neq k} {\hat{h}}_{j}^{*} {\hat{h}}_{j}^{T} \frac{{P}_{F}}{K} KE [ Δ {\hat{h}}_{j}^{*} Δ {\hat{h}}_{j}^{T} ] \frac{{P}_{F}}{K} + I )}^{- 1} {\hat{h}}_{k}^{*}$$

As a result,

$${u}_{k} = {{c}_{k} ( {\sum }_{j \neq k} {\hat{h}}_{j}^{*} {\hat{h}}_{j}^{T} \frac{{P}_{F}}{K} + \frac{{P}_{F}}{{P}_{R} + 1} I + I )}^{- 1} {\hat{h}}_{k}^{*} \qquad ( 20 )$$

where the scaling constant cₖ is chosen so that ∥u_{K}∥=1.

### B. MMSE Minimization

The problem definition is

$${min}_{U , β} E [ {‖ ( β y - s ) ‖}^{2} ] s . t . E [ {‖ ( Us ) ‖}^{2} ] = {P}_{F} U {,}^{-}$$

Consider the following:

$$\begin{matrix}E [ {‖ ( β y - s ) ‖}^{2} ] = E [ {‖ ( β ( \hat{H} + Δ H ) Us - s ) ‖}^{2} ] \\ = Tr ( β {P}_{F} \hat{H} {UU}^{†} {\hat{H}}^{†} - β {P}_{F} \hat{H} U - β {P}_{F} {U}^{†} {\hat{H}}^{†} {P}_{F} I ) \\ {β}^{2} {P}_{F} E [ TR ( Δ \hat{H} {UU}^{†} Δ {H}^{†} ) ] + {β}^{2} Tr ( I )\end{matrix}$$

The power constraint can be simplified to

E[∥Us∥²]P_{F}Tr(UU^{†}). (21)

The Lagrangian formulation as shown below is used to start.

$$\begin{matrix} ( U , β , λ ) = TR ( {β }^{2} {P}_{F} \hat{H} {UU}^{†} - β {P}_{F} \hat{H} U ) - \\ TR ( β {P}_{F} {U}^{†} {\hat{H}}^{†} - {P}_{F} I ) + \\ {β}^{2} {P}_{F} E [ Tr ( Δ {HUU}^{†} Δ {H}^{†} ) ] + \\ {β}^{2} Tr ( I ) + λ ( {P}_{F} Tr ( {UU}^{†} ) ) . \\ = TR ( {P}_{F} {U}^{†} ( {β}^{2} {\hat{H}}^{†} \hat{H} \frac{K {β}^{2}}{{P}_{R} + 1} I + λ I ) U - β {P}_{F} \hat{H} U ) - \\ TR ( β {P}_{F} {U}^{†} {\hat{H}}^{†} ) + - Tr ( {P}_{F} I + {β}^{2} I ) \\ = {‖ A - B ‖}^{2} - {P}_{F} Tr ( {\hat{H} ( {\hat{H}}^{†} H + μ I )}^{- 1} {\hat{H}}^{†} - \\ ( {P}_{F} + {β}^{2} ) I )\end{matrix} \qquad ( 22 )$$

where

$$A = \sqrt{β} {( {\hat{H}}^{†} \hat{H} + μ I )}^{\frac{1}{2}} U$$

$$B = {( {\hat{H}}^{†} \hat{H} + μ I )}^{\frac{1}{2}} {\hat{H}}^{†} \frac{1}{\sqrt{β}}$$

$$μ = \frac{λ}{{β}^{2}} + \frac{K}{{P}_{R} + 1} .$$

As a result,

$${U}^{opt} = \frac{{( {\hat{H}}^{†} \hat{H} + μ I )}^{- 1} {\hat{H}}^{†}}{{β}^{*}} \qquad ( 23 )$$

where β* satisfies the precoder power constraint. The unconstrained minimization of MSE with respect to μ results in

$${μ}^{*} = \frac{K}{{P}_{F}} + \frac{K}{{P}_{R} + 1}$$

### ADVANTAGES OF EMBODIMENTS OF THE INVENTION

There are a number of advantages associated with embodiments of the present invention. One such advantage of an embodiment of this invention, with respect to single-user MIMO systems, is that multi-user MIMO receivers are much simpler to implement than the corresponding single-user MIMO receivers with the same system spectral efficiency. Complexity is significantly lowered since there is no need to jointly demap multiple streams at the inner decoder. Complexity is also further lowered in multi-user MIMO receivers, since unlike conventional single-user MIMO systems where a user has to demodulate at the aggregate transmission rate, each multi-user MIMO receiver decodes only its own signal. The receiver form factor is also much more manageable. With a single antenna at each receiver, the multi-user MIMO designs described herein can provide aggregate data rates that can be as high or even higher than those of the 6×6 and even 12×12 single-user MIMO systems (which require 6 and 2 antenna elements at the receiver, respectively).

In the multi-user MIMO system, complexity is transferred from the receiver to the transmitter. Since the transmitter is a common resource that is not required to be mobile, this is a system advantage. Furthermore, the (base-station) precoder complexity does not grow exponentially, but rather as K to the cube at most.

One innovation is the general four-stage training and transmission in FIG. 7, including a downlink channel estimation scheme with L pilots. This scheme provides robust performance even with L=1 pilot. The scheme also can approach the perfect CSIR throughput with just a few pilots. For example, for the N=100 and K=50 case, L=5 suffices to get very close to the perfect CSIR case. Ideally this would require 50 pilots. Therefore, the reduction in training duration is around 90% without resulting in a considerable loss of performance.

Another advantage of one embodiment of the invention is the fact that a low-complexity linear precoder can be used when the number of transmit antennas N is significantly larger than K. When K and N are close, a nonlinear type of precoder should be used, like those employing, for example “dirty paper coding” techniques. The precoder is robust to CSIT quality, and to a certain extent, to increases in the number of users.

### An Example of One Embodiment of a Computer System

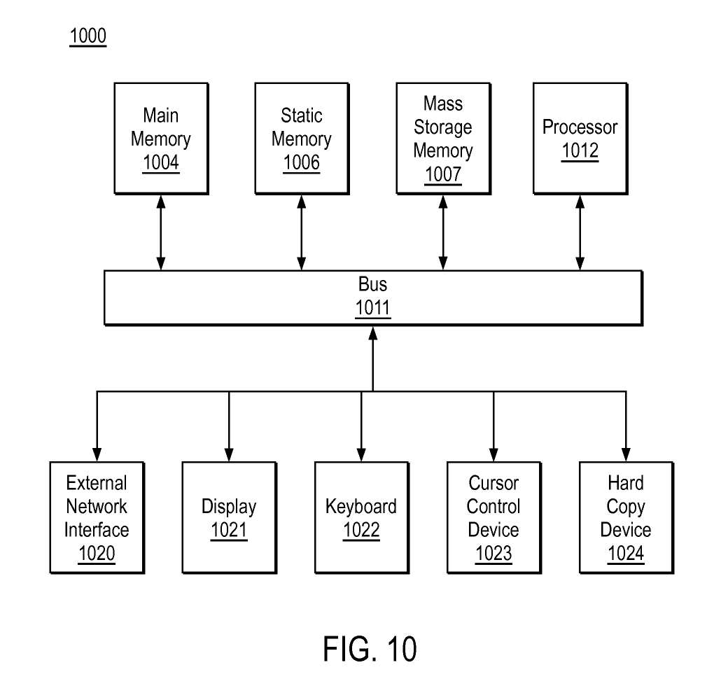

FIG. 10 is a block diagram of an exemplary computer system that may perform one or more of the operations described herein. Referring to FIG. 10, computer system 1000 may comprise an exemplary client or server computer system. Computer system 1000 comprises a communication mechanism or bus 1011 for communicating information, and a processor 1012 coupled with bus 1011 for processing information. Processor 1012 includes a microprocessor, but is not limited to a microprocessor, such as, for example, Pentium™, PowerPC™, Alpha™, etc.

System 1000 further comprises a random access memory (RAM), or other dynamic storage device 1004 (referred to as main memory) coupled to bus 1011 for storing information and instructions to be executed by processor 1012. Main memory 1004 also may be used for storing temporary variables or other intermediate information during execution of instructions by processor 1012.

Computer system 1000 also comprises a read only memory (ROM) and/or other static storage device 1006 coupled to bus 1011 for storing static information and instructions for processor 1012, and a data storage device 1007, such as a magnetic disk or optical disk and its corresponding disk drive. Data storage device 1007 is coupled to bus 1011 for storing information and instructions.

Computer system 1000 may further be coupled to a display device 1021, such as a cathode ray tube (CRT) or liquid crystal display (LCD), coupled to bus 1011 for displaying information to a computer user. An alphanumeric input device 1022, including alphanumeric and other keys, may also be coupled to bus 1011 for communicating information and command selections to processor 1012. An additional user input device is cursor control 1023, such as a mouse, trackball, trackpad, stylus, or cursor direction keys, coupled to bus 1011 for communicating direction information and command selections to processor 1012, and for controlling cursor movement on display 1021.

Another device that may be coupled to bus 1011 is hard copy device 1024, which may be used for marking information on a medium such as paper, film, or similar types of media. Another device that may be coupled to bus 1011 is a wired/wireless communication capability 1025 to communication to a phone or handheld palm device.

Note that any or all of the components of system 1000 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A wireless communication system comprising:
a set of K receivers;
at least one transmitter having a set of N transmit antennas, the at least one transmitter being operable to precode a signal for downlink transmission to each receiver in the set of K receivers based on multi-user MIMO using precoding derived based on two-way channel training between the set of K receivers and the set of N transmit antennas.

2. The wireless communication system defined in claim 1 wherein the two-way channel training includes uplink training using K pilot signals and downlink training using 1 to K symbols.

3. The wireless communication system defined in claim 1 wherein the precoding is performed using one or more MU-MIMO precoders derived via reciprocity-derived channel state information at the transmitter (CSIT).

4. The wireless communication system defined in claim 3 wherein the CSIT is acquired by measurements made at the transmitter based on pilots sent by the set of K receivers.

5. The wireless communication system defined in claim 1 further comprising a two-way training module to coordinate the two-way training.

6. The wireless communication system defined in claim 1 wherein the set of K receivers and the set of N transmit antennas employ a four stage TDD-based training and transmission protocol.

7. The wireless communication system defined in claim 6 wherein the four stage TDD-based training and transmission protocol comprises:
the transmitter estimating channels directly based on received on K pilot symbols, each K pilot symbol being transmitted by one of the set of K receivers;
deriving the MU-MIMO precoder using the channel estimates;
the transmitter transmitting 1 to K pilot symbols using the MU-MIMO precoder to the set of K receivers to enable the K receivers to estimate their respective effective channels; and
the transmitter performing unicast downlink transmission using the MU-MIMO precoder.

8. The wireless communication system defined in claim 7 where the 1 to K pilot symbols are spread between data samples of the down-link transmission.

9. The wireless communication system defined in claim 1 wherein the at least one transmitter comprises a plurality of precoders, wherein each of the plurality of precoders is dedicated to one channel.

10. The wireless communication system defined in claim 1 wherein the at least one transmitter generates a compound precoded signal using channel estimates generated by the at least one transmitter, the compound precoded signal being such that each receiver in the set of K receivers only decodes its own signal.

11. The wireless communication system defined in claim 1 wherein the at least one transmitter comprises a unit to estimate channels directly and a space-time encoding system comprising:
an input to receive information bearing signals;
a binary outer code encoder coupled to the input to encode the information bearing signals and generate a bit stream;
a bit interleaver coupled to receive the bit stream;
a mapper and a modem coupled to the bit interleaver, wherein the bit interleaver, mapper and modem operate together to perform bit-interleaved coded modulation;
a set of precoders to shape signals for transmission based on channel state information indicative of channel estimates that were estimated directly by the unit of the transmitter; and
an OFDM-based inner orthogonal space-time block code encoder coupled to the set of precoders to generate a plurality of streams for transmission.

12. The wireless communication system defined in claim 11 wherein the modem and the set of precoders are coupled via a serial-to-parallel converter that is operable to convert outputs of the bit-interleaving from serial to parallel form.

13. The wireless communication system defined in claim 11 wherein the unit derives the set of precoders.

14. The wireless communication system defined in claim 1 wherein at least one of the set of K receivers comprises:
a linear front-end having an inner decoder to perform decoding with an OFDM-based inner orthogonal space-time block code to generate symbols; and
an outer decoder having
an inner symbol demapper to perform a symbol-by-symbol demapping of symbols to bits from the linear front-end,
a bit deinterleaver to perform deinterleaving on the demapped symbols received from the inner symbol demapper, and
an outer MAP decoder.

15. The wireless communication system defined in claim 1 wherein the at least one transmitter comprises a base station.

16. A method comprising:
performing two-way channel training between at least one transmitter having a set of N transmit antennas and a set of K receivers in a wireless communication system; and
precoding a signal for downlink transmission to each receiver in the set of K receivers based on multi-user MIMO, where the precoding is derived based on two-way channel training between the set of K receivers and the set of N transmit antennas.

17. The method defined in claim 16 wherein performing two-way channel training comprises performing uplink training using K pilot signals sent from the set of K receivers to the at least one transmitter and performing downlink training using 1 to K symbols transmitted from the at least one transmitter to the set of K receivers.

18. The method defined in claim 16 wherein the precoding is performed using one or more MU-MIMO precoders derived via reciprocity-derived channel state information at the transmitter (CSIT).

19. The method defined in claim 16 further comprising performing a four stage TDD-based training and transmission protocol between the set of K receivers and the at least one transmitter, wherein the four stage TDD-based training and transmission protocol comprises at least:
the transmitter estimating channels directly based on received K pilot symbols, each of the K pilot symbols being transmitted by one of the set of K receivers;
deriving a MU-MIMO precoder using the channel estimates;
the transmitter transmitting 1 to K pilot symbols using the MU-MIMO precoder to the set of K receivers to enable the K receivers to estimate their respective effective channels; and
the transmitter performing unicast downlink transmission using the MU-MIMO precoder.

20. The method defined in claim 19 wherein the transmitter comprises a plurality of precoders, and deriving the MU-MIMO precoder comprises applying a plurality of precoders, and dedicated to one channel.

21. A method for use in a wireless communication system having at least one transmitter and a set of K receivers, the method comprising:
a transmitter receiving K pilot symbols, each K pilot symbol being transmitted by one of the set of K receivers;
estimating channels directly at the transmitter based on received K pilot symbols;
deriving a MU-MIMO precoder using the channel estimates;
transmitting 1 to K pilot symbols using the MU-MIMO precoder to the set of K receivers to enable the K receivers to estimate their respective effective channels; and
sending a downlink transmission using the MU-MIMO precoder to at least one of the set of K receivers.

22. The method defined in claim 21 wherein the transmitter comprises a plurality of precoders, and deriving the MU-MIMO precoder comprises applying a plurality of precoders, and dedicated to one channel.

23. The method defined in claim 21 wherein deriving the MU-MIMO precoder is performed using reciprocity-derived channel state information at the transmitter (CSIT).

24. The method defined in claim 21 wherein the MU-MIMO precoder comprises a plurality of precoders, wherein each of the plurality of precoders is dedicated to one channel.

25. The method defined in claim 21 wherein sending the downlink transmission comprises generating a compound precoded signal using channel estimates generated by the at least one transmitter, the compound precoded signal being such that each receiver in the set of K receivers only decodes its own signal.
